(19) United States
(12) Patent Application Publication
(10) Pub. No.: US 2005/0248695 A1
(43) Pub. Date: Nov. 10, 2005

(54) Backlight system

(75) Inventor: Junji Miyashita, Fujiyoshida-shi (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., Ltd., Fujiyoshida-shi (JP)

(21) Appl. No.: 11/118,763

(22) Filed: May 2, 2005

(30) Foreign Application Priority Data
Apr. 30, 2004 (JP) P2004-136754

(51) Int. Cl. G02F 1/1335

(52) U.S. Cl. 349/65

(57) ABSTRACT

A backlight system is provided which comprises a light guide plate formed with a light diffusion surface to reflect light from a light source and a reflection sheet positioned on the light diffusion surface side of the light guide plate. A light scattering area to positively scatter light is formed in the reflection sheet at a position adjacent to the light source to eliminate brightness variations in light rays emitted from the light guide plate, thereby producing a uniform brightness in a planar light emission.

The application claims the priority benefit of Japanese Patent Application No.2004-136754, filed on Apr. 30, 2004, the entire descriptions of which are incorporated herein by reference.

### BACKGROUND OF THE INVENTION

1. Field of the Invention

The present invention relates to a backlight system that illuminates a transparent or semi-transparent panel from its back.

2. Related Art Statement

A large number of thin liquid crystal displays having a backlight system are in wide use today on laptop or notebook word processors or personal computers. As an example of the backlight system using an edge-light type light-source unit is known in which, as disclosed in an official gazette of Japanese Patent Disclosure No. 2001-229725 (page 2, FIGS. 4-6), a surface mount type LED is disposed adjacent to one side of a light guide plate, with a display panel arranged on a light emitting surface side of the light guide plate.

FIG. 5 to FIG. 8 show an outline of a conventional backlight system similar to the backlight system disclosed in the above official gazette. This backlight system has a light guide plate 20 almost rectangular in plan view, formed by a transparent plastic member, and a plurality of LEDs 21 arranged close to one shorter side 24 of the light guide plate 20. The light guide plate 20 has a light emitting surface 20a formed in one of its planar surfaces and a light diffusion surface 20b formed in the other, opposite surface. The light diffusion surface 20b reflects light from the LEDs 21 toward the light emitting surface 20a. The light diffusion surface 20b is formed on one entire planar surface of the light guide plate 20 by using a plurality of fine textured undulations or raised dots, or prisms with a particular inclination angle. It can also be formed by printing.

On the light emitting surface 20a side of the light guide plate 20 is placed a prism sheet 22 which has a plurality of microprisms 22a on one surface. These microprisms 22a are arranged parallel to one shorter side 25 of the prism sheet 22 to provide the prism sheet 22 with a function as a brightness enhancing film. The prism sheet 22 matches the size of the display panel and is disposed so that the microprisms 22a face the light emitting surface 20a of the light guide plate 20.

On the underside of the light guide plate 20 a reflection sheet 23 is arranged close to the light diffusion surface 20b. The reflection sheet 23 has a glossy metallic mirror surface 23a on a side facing the light diffusion surface 20b.

Light emitted from the LEDs 21 enters the light guide plate 20 and is repetitively reflected therein as it travels inside the light guide plate 20. Those rays of light that are reflected or refracted by the light diffusion surface 20b on the underside of the light guide plate 20 go out through the light emitting surface 20a of the light guide plate 20. Those rays that have passed through the light diffusion surface 20b are reflected by the metallic mirror surface 23a to go out through the light emitting surface 20a. The rays that have left the light guide plate 20 through the light emitting surface 20a now enter the prism sheet 22. As they pass through the prism sheet 22, the rays are totally reflected by the microprisms 22a, increasing the brightness of the light, so that the liquid crystal panel is illuminated at an increased brightness.

In the backlight system of the above construction, however, since three LEDs 21 arranged close to one side 24 of the light guide plate 20 are point light sources, there are formed dark areas 26 in the light guide plate 20 adjacent to and between the LEDs 21 as shown in FIG. 8. Also, since the LEDs 21 are point light sources, intense emission lines may appear, depending on an angle to a liquid crystal panel. Those may result in brightness variations.

### SUMMARY OF THE INVENTION

To solve the above problem, the present invention provides a backlight system which comprises: a light guide plate formed with a light diffusion surface to reflect rays of light from a light source; and a reflection sheet positioned on the light diffusion surface side of the light guide plate; wherein a light scattering area to positively scatter light is formed in the reflection sheet at a position adjacent to the light source.

In one aspect of this invention, the light scattering area takes the form of a line shape with a width of 3 mm or less extending from one side which is adjacent to the light source side.

In another aspect of this invention, the light scattering area takes the form of a matte-finished, white light scattering surface.

The provision of the light scattering area in the backlight system of this invention eliminates brightness variations in the rays of light emitted from the light guide plate, thus producing a uniform brightness in the planar light emission.

### BRIEF DESCRIPTION OF THE DRAWINGS

FIG. 1 is a cross-sectional view showing a construction of a backlight system in an embodiment according to this invention.

FIG. 2 is a plan view showing a reflection sheet used in an embodiment according to this invention.

FIG. 3 is a cross-sectional view showing paths of light rays near LEDs in the backlight system in an embodiment according to this invention.

FIG. 4 is a perspective view showing a light emitting surface of a light guide plate used in an embodiment according to this invention.

FIG. 5 is a cross-sectional view showing a construction of a conventional backlight system.

FIG. 6 is a plan view showing a reflection sheet used in the conventional backlight system.

FIG. 7 is a cross-sectional view showing paths of light rays near LEDs in the conventional backlight system.

FIG. 8 is a plan view showing dark areas in the light guide plate formed near the LEDs in the conventional backlight system.

### DETAILED DESCRIPTION OF THE PREFERRED EMBODIMENTS

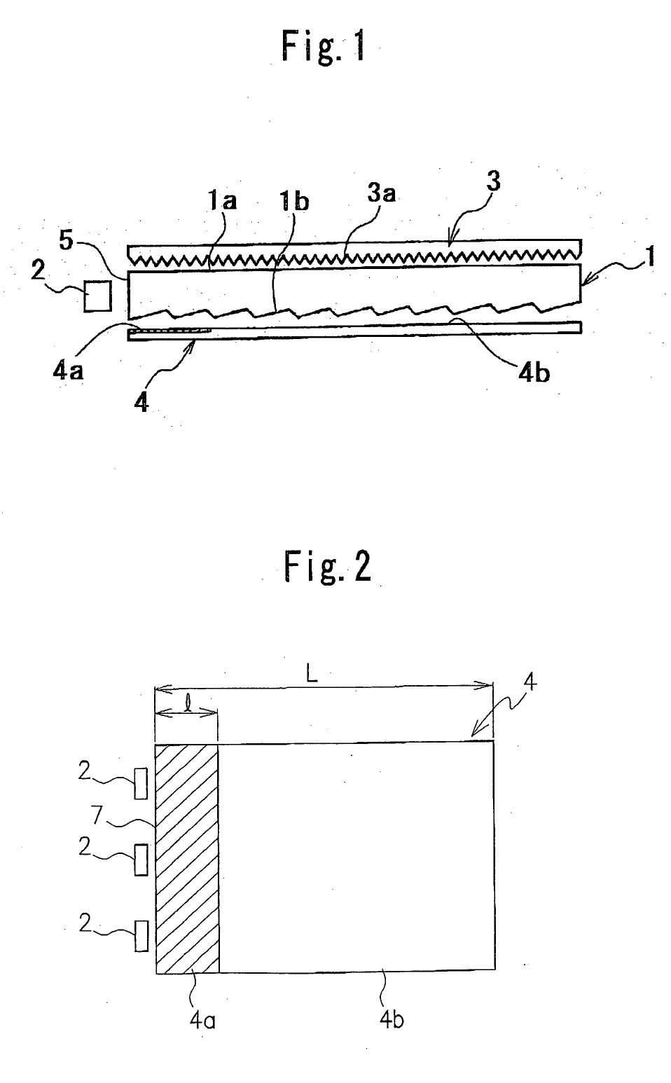

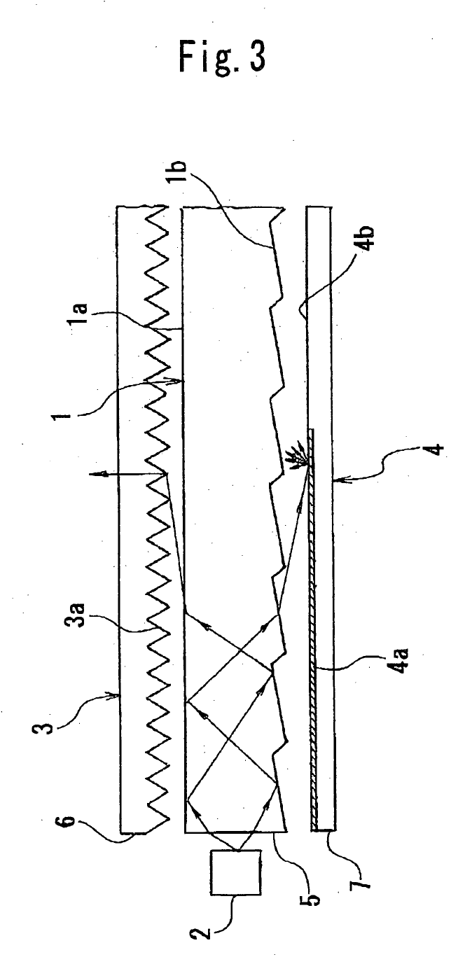

Now, a preferred embodiment of this invention will be described in detail by referring to the accompanying drawings. FIG. 1 to FIG. 4 show a backlight system of one embodiment of this invention. This backlight system comprises a light guide plate 1 almost rectangular in plan view, formed of a transparent plastic member, and a plurality of LEDs 2 arranged adjacent to one shorter side of the light guide plate 1. The light guide plate 1 has a light emitting surface 1a formed in one of its planar surfaces and a light diffusion surface 1b formed in the other, opposite surface. The light diffusion surface 1b reflects light from the LEDs 2 toward the light emitting surface 1a. The light diffusion surface 1b is formed on one entire planar surface of the light guide plate 1 by using a plurality of fine textured undulations or raised dots, or prisms with a particular inclination angle. It can also be formed by printing.

On the light emitting surface 1a side of the light guide plate 1 is placed a prism sheet 3 which has a plurality of microprisms 3a on one surface. These microprisms 3a are arranged parallel to one shorter side 6 of the prism sheet 3 to provide the prism sheet 3 with a function as a brightness enhancing film. The prism sheet 3 matches the size of the display panel (not shown) and is disposed so that the microprisms 3a face the light emitting surface 1a of the light guide plate 1.

A reflection sheet 4 is arranged adjacent to the light diffusion surface 1b of the underside of the light guide plate 1. The reflection sheet 4 has formed on one surface facing the light diffusion surface 1b a light scattering area 4a to positively scatter light and a light reflection area 4b to reflect light, the two areas being disposed next to each other. The light scattering area 4a is positioned adjacent to the LEDs 2 in the form of a strip which is a predetermined distance 1 wide from a shorter side 7 of the reflection sheet 4 and extends over the entire width, or shorter side, of the reflection sheet 4. The predetermined distance 1 is shorter than the overall length L of the reflection sheet 4 and may, for example, be set in a range of less than 3 mm. The light scattering area 4a may be formed by printing as a non-glossy, matte-finished, white light scattering surface.

The light reflection area 4b is formed in a wider area adjoining the light scattering area 4a, i.e., over the entire area of the reflection sheet 4 excluding the light scattering area 4a. The light reflection area 4b has a function of reflecting light and, in this example, is formed as a glossy metallic surface.

In this embodiment, three white LEDs 2 are arranged at predetermined intervals along one shorter side 5 of the light guide plate 1. The light emitted from the LEDs 2 enters the light guide plate 1 and is repetitively reflected therein as it travels inside the light guide plate 1 until it leaves the light guide plate 1. Of the rays of light leaving the light guide plate 1, those rays that are emitted toward the reflection sheet 4 adjacent to the LEDs 2 are scattered in all directions by the light scattering area 4a of the reflection sheet 4. In other words, the light that is emitted from the LEDs and enter the light scattering area 4a of the reflection sheet are changed to a linear light source on the light scattering area 4a. The remaining rays are repetitively reflected within the light guide plate 1 as they travel. Then, the rays reflected or refracted by the light diffusion surface 1b on the underside of the light guide plate 1 are emitted from the light emitting surface 1a of the light guide plate 1. Those rays that have passed through the light diffusion surface 1b are reflected by the metallic mirror surface of the light reflection area 4b of the reflection sheet 4 before being emitted from the light emitting surface 1a of the light guide plate 1. The rays that are emitted from the light emitting surface 1a of the light guide plate 1 enter the prism sheet 3 and are totally reflected by the microprisms 3a to increase the brightness as they pass through and leave the prism sheet 3, thus illuminating the liquid crystal panel (not shown) at an increased brightness.

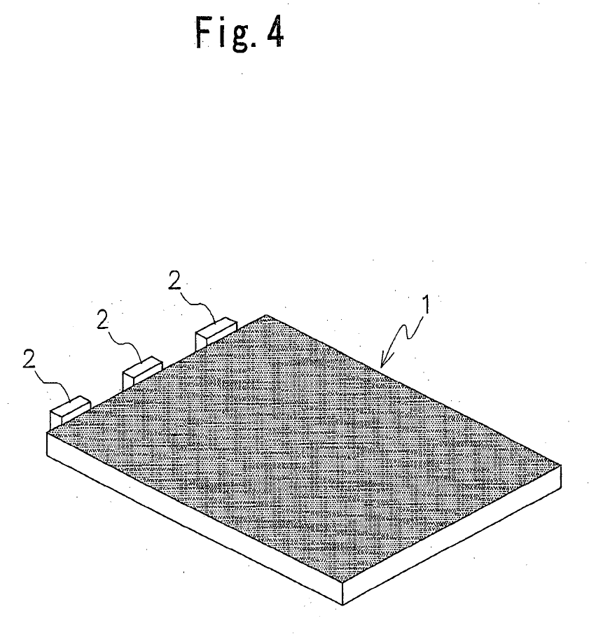

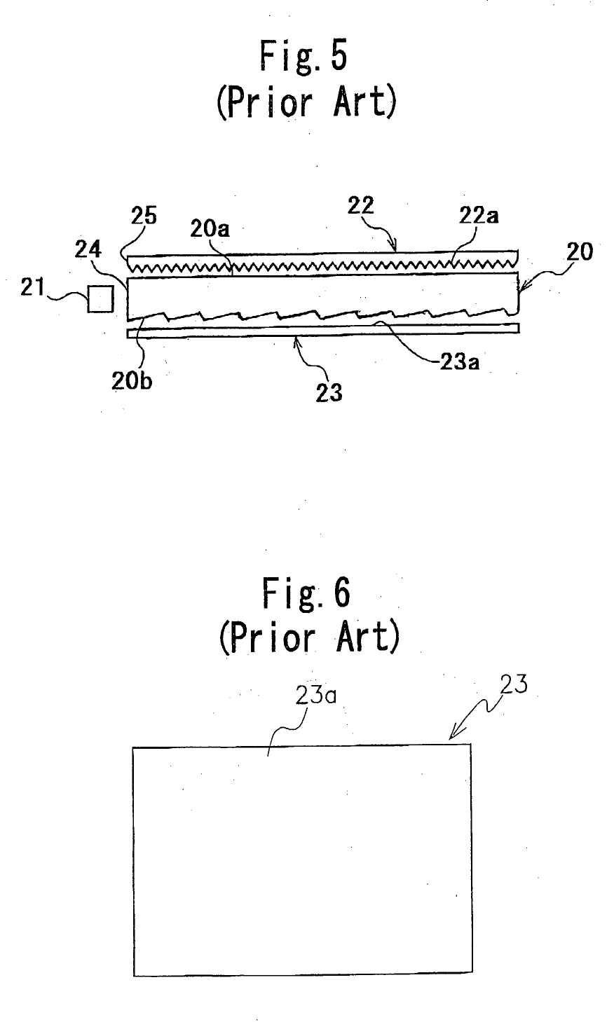

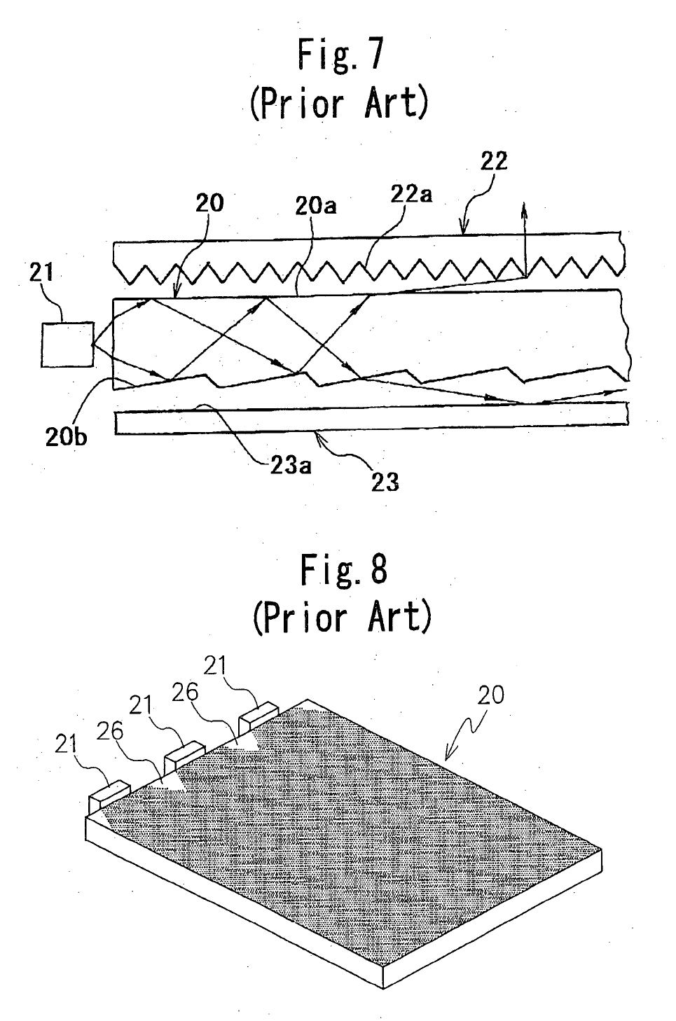

As described above, since in the backlight system of this invention the light scattering area 4a is formed in the reflection sheet 4 provided on the bottom side of the light guide plate 1, rays of light are scattered adjacent to the LEDs 2 to eliminate brightness variations adjacent to the LEDs 2, providing a uniform brightness in a planar light emission, as shown in FIG. 4. Particularly, since in the above embodiment the light scattering area 4a is formed like a strip over the entire width of the reflection sheet 4, the uniform brightness producing effect is further enhanced.

1. A backlight system comprising:
a light guide plate almost rectangular in plan view, having a light emitting surface on one of its planar surfaces and a light diffusion surface on the other opposite surface to reflect rays of light from a light source;
a light source positioned adjacent to one side of the light guide plate;
a prism sheet positioned on the light emitting surface side of the light guide plate; and
a reflection sheet positioned on the light diffusion surface side of the light guide plate;
wherein a light scattering area to positively scatter light is formed in the reflection sheet at a position adjacent to the light source.

2. A backlight system according to claim 1, wherein the light scattering area formed in the reflection sheet takes the form of a line shape with a width of 3 mm or less extending from one side which is adjacent to the light source side.

3. A backlight system according to claim 1, wherein the light scattering area formed in the reflection sheet is a matte-finished, white light scattering surface.

4. A backlight system according to claim 1, wherein the reflection sheet is formed with a light reflection area next to the light scattering area to reflect light.

5. A backlight system according to claim 4, wherein the light reflection area formed in the reflection sheet is a glossy, metallic mirror surface.
